(19) United States
(12) Patent Application Publication
(10) Pub. No.: US 2007/0216498 A1
(43) Pub. Date: Sep. 20, 2007

(54) LOW-PASS FILTER

(75) Inventor: HSIN-PING CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,583

(22) Filed: Aug. 25, 2006

(30) Foreign Application Priority Data
Mar. 17, 2006 (TW) 95109270

(51) Int. Cl. H01P 1/203

(52) U.S. Cl. 333/204

(57) ABSTRACT

A low-pass filter (10) includes an input line (100), an output line (120), a high impedance transmission line (140), a first low impedance transmission line (160), a second low impedance transmission line (180), and a stub (190). The high impedance transmission line includes a first connecting portion (142) electronically connected to the input line, and a second connecting portion (144) electronically connected to the output line. The first low impedance transmission line includes a third connecting portion (162) electronically connected to the first connecting portion, and a first free end (164). The second low impedance transmission line includes a fourth connecting portion (182) electronically connected to the second connecting portion, and a second free end (184). The stub includes a fifth connecting portion (192) electronically connected to the first connecting portion and the second connecting portion, and a third free end (194).

### FIELD OF THE INVENTION

The present invention generally relates to a filter, and more particularly to a low-pass filter.

### RELATED ART

Conventionally, when a wireless network product is working under a high power condition, harmonic components of high frequencies are generated due to the nonlinear properties of the active components, thereby causing electromagnetic interference (EMI).

For solving the above problem, the manufacturers of such wireless network products often use a filter to suppress the noise generated by the harmonic components.

Referring to FIG. 5, a conventional filter 40 is shown. The low-pass filter 40 includes an input line 400, an output line 420 aligned with the input line 400, a high impedance transmission line 440 connected to the input 400 and the output 420, a rectangular first low impedance transmission line 460 connected to the high impedance transmission line 440, and a rectangular second low impedance transmission line 480 parallel to the first low impedance transmission line 460 and connected to the high impedance transmission line 440. The input line 400 is used to input the electromagnetic signal. The output line 420 is used to output the electromagnetic signal. The input line 400 and the output line 1420 have impedance values of approximately 50 ohms, respectively. The high impedance transmission line 440 is in a meandering shape. A slot 490 is formed between the first low impedance transmission line 460 and the second low impedance transmission line 480. The first low impedance transmission line 460 and the second low impedance transmission line 480 have the same length and width.

FIG. 6 is a diagram showing a relationship between an insertion or return loss and frequency of an electromagnetic signal traveling through the filter 40. As shown, the rejection bandwidth of the filter 40 at −25 dB is generally 7.5 GHz. However, the filter 40 cannot suppress the generated noise of harmonic components of over 7.5 GHz.

Therefore, a heretofore unaddressed need exists in the industry to overcome the aforementioned deficiencies and inadequacies.

### SUMMARY

In an exemplary embodiment, a low-pass filter includes an input line for input of an electromagnetic signal, an output line for output of the electromagnetic signal, a high impedance transmission line, a first low impedance transmission line, a second low impedance transmission line, and a stub. The high impedance transmission line includes a first connecting portion electronically connected to the input line, and a second connecting portion electronically connected to the output line. The first low impedance transmission line includes a third connecting portion electronically connected to the first connecting portion, and a first free end. The second low impedance transmission line includes a fourth connecting portion electronically connected to the second connecting portion, and a second free end. The stub includes a fifth connecting portion electronically connected to the first connecting portion and the second connecting portion, and a third free end.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a low-pass filter of an exemplary embodiment of the invention;

FIG. 2 is a diagram showing a relationship between insertion or return loss and frequency of electromagnetic signals through the low-pass filter of FIG. 1;

FIG. 3 is a schematic diagram of a low-pass filter of another exemplary embodiment of the invention; and

FIG. 4 is a diagram showing a relationship between insertion or return loss and frequency of electromagnetic signals through the low-pass filter of FIG. 3;

FIG. 5 is a schematic diagram of a conventional filter; and

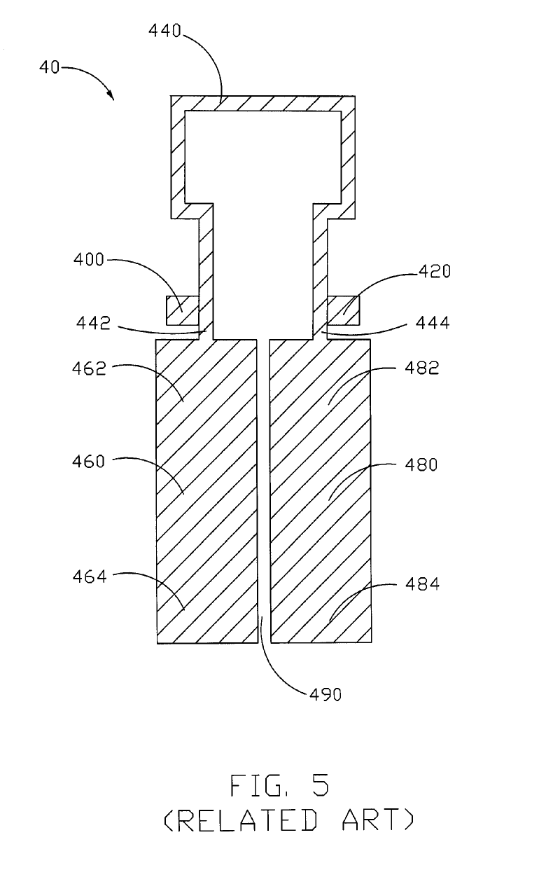

FIG. 6 is a diagram showing a relationship between insertion or return loss and frequency of electromagnetic signals through the filter of FIG. 5.

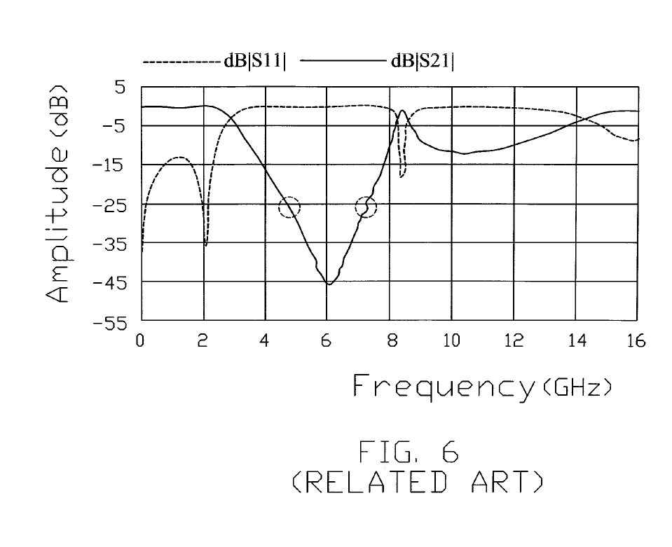

### DETAILED DESCRIPTION OF THE EMBODIMENTS

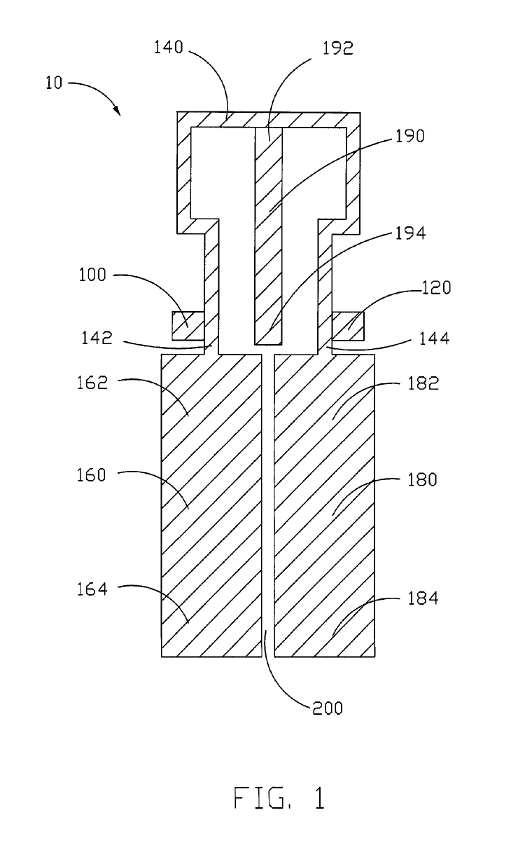

FIG. 1 is a schematic diagram of a low-pass filter 10 of an exemplary embodiment of the present invention. The low-pass filter 10 includes an input line 100, an output line 120 aligned with the input line 100, a high impedance transmission line 140, a first rectangular low impedance transmission line 160, a second rectangular low impedance transmission line 180 parallel to the first low impedance transmission line 160, and a rectangular stub 190.

The input line 100 is used to input electromagnetic signals. The output line 120 is used to output the electromagnetic signals. The input line 100 and the output line 120 have impedance values of approximately 50 ohms, respectively.

A slot 200 is formed between the first low impedance transmission line 160 and the second low impedance transmission line 180.

The high impedance transmission line 140 comprises a first connecting portion 142 electrically connected to the input line 100, and a second connecting portion 144 electrically connected to the output line 120. The first connecting portion 142 and the second connecting portion 144 are symmetrical about the stub 190. The first low impedance transmission line 160 comprises a third connecting portion 162 electrically connected to the first connecting portion 142, and a first free end 164. The second low impedance transmission line 180 comprises a fourth connecting portion 182 electrically connected to the second connecting portion 144, and a second free end 184.

The stub 190 is disposed centrally in the high impedance transmission line 140. The stub 190 comprises a fifth connecting portion 192 electrically connected to the first connecting portion 142 and the second connecting portion 144 at a middle portion of the high impedance transmission line 140, and a third free end 194 opposite to the slot 200. The high impedance transmission line 140 is arranged to extend symmetrically about the stub 190.

In this embodiment, a perimeter of the high impedance transmission line 140 is 10.85 mm. A line width of the high impedance transmission line 140 is 0.23 mm. A length and a width of the first low impedance transmission line 160 are respectively 4.55 mm and 1.65 mm. A length and a width of the second low impedance transmission line 180 are equal to those of the first low impedance transmission line 160, respectively. A length and a width of the stub 190 are respectively 3.23 mm and 0.38 mm.

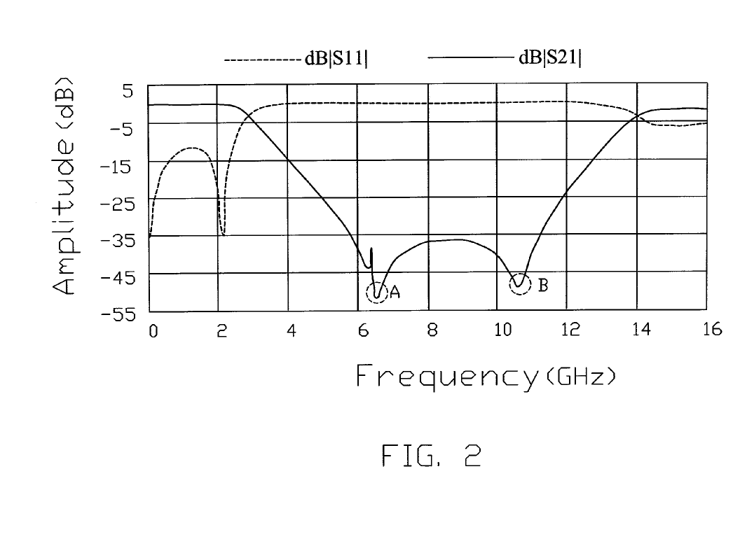

FIG. 2 is a diagram showing a relationship between an insertion or return loss and frequency of an electromagnetic signal traveling through the low-pass filter 10. The horizontal axis represents the frequency in gigahertz (GHz) of the electromagnetic signal traveling through the low-pass filter 10, and the vertical axis represents the insertion or return loss in decibels (dB) of the low-pass filter 10. The curve S21 represents the insertion loss indicating a relationship between input power and output power of the electromagnetic signals traveling through the low-pass filter 10, and the insertion loss is represented by the following equation:

Insertion Loss=−10*Lg[(Input Power)/(Output Power)].

When the electromagnetic signals travel through the low-pass filter 10, a part of the input power is returned to a source of the electromagnetic signal. The part of the input power returned to the source of the electromagnetic signal is called return power. The curve S11 represents the return loss indicating a relationship between the input power and the return power of the electromagnetic signal traveling through the low-pass filter 10, and the return loss is represented by the following equation:

Return Loss=−10*Lg[(Input Power)/(Return Power)]

For a filter, when the output power of the electromagnetic signal in a pass band frequency range is close to the input power of the electromagnetic signal, and the return power of the electromagnetic signal is small, it means that a distortion of the electromagnetic signal is small and the performance of the low-pass filter is good. That is, the smaller the absolute value of the insertion loss of the electromagnetic signal is, and the bigger the absolute value of the return loss of the electromagnetic signal is, the better the performance of the filter is. As shown in the curve S21 of FIG. 2, the absolute value of the insertion loss of the electromagnetic signal in the pass band frequency range is close to 0. In the curve S11, the absolute value of the return loss of the electromagnetic signal in the pass band frequency range is greater than 10, and the absolute value of the return loss of the electromagnetic signal beyond the pass band frequency range is less than 10. Therefore, the low-pass filter 10 has good performance.

Because the stub 190 of the low-pass filter 10 is a short circuit, a transmission zero point A and a transmission zero point B are formed in the low-pass filter 10, and the rejection bandwidth of the low-pass filter 10 at −25 dB is generally 12 GHz. Meanwhile, because the third free end 194 of the stub 190 and the first low impedance transmission line 160 and the second low impedance transmission line 180 have a coupled capacitance, the curve S21 in the pass band frequency range is a smooth generally horizontal line. Therefore, filtering function of the low-pass filter 10 is improved.

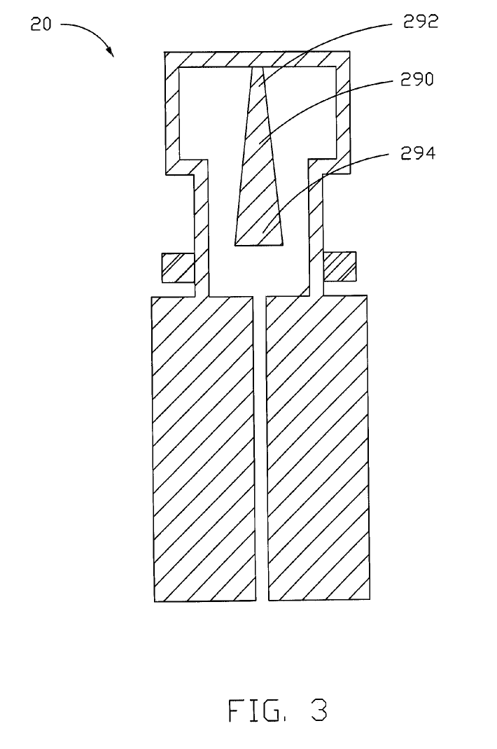

FIG. 3 is a schematic diagram of a low-pass filter 20 of another exemplary embodiment of the present invention. The low-pass filter 20 has a structure similar to the low-pass filter 10 as detailed above, except that the low-pass filter 20 comprises a trapeziform stub 290. A length of the stub 290 is less than that of the stub 190 of the low-pass filter 10. The stub 290 comprises a third free end 294 and a fifth connecting portion 292, and a width of the fifth connecting portion 292 is greater than that of the third free end 294. The other elements of the low-pass filter 20 are the same as the low-pass filter 10. The low-pass filter 20 can perform the same function as the low-pass filter 10.

In the embodiment, a length of the stub 290 is 2.81 mm. A line width of the third free end 294 of the stub 290 is 0.38 mm. Lengths and widths of the other elements of the low-pass filter 20 are equal to those of the same elements of the low-pass filter 10, respectively.

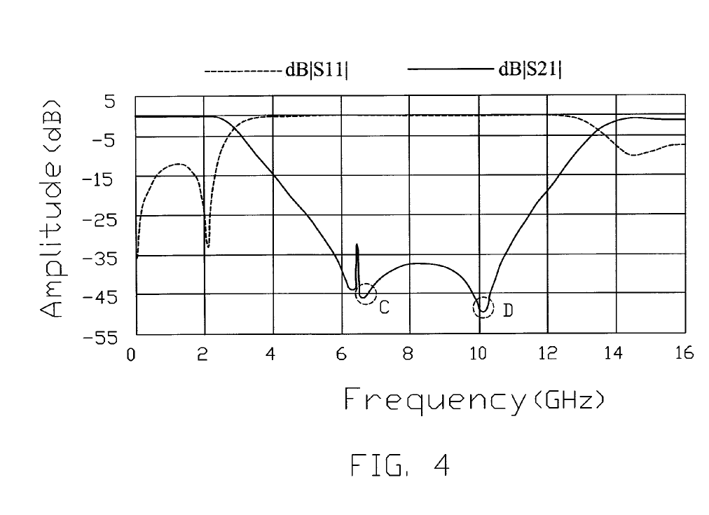

FIG. 4 is a diagram showing a relationship between an insertion or return loss and frequency of an electromagnetic signal traveling through the low-pass filter 20. The absolute value of the insertion loss of the electromagnetic signal in the low-pass frequency range is close to 0, as shown in curve S21, and the absolute value of the return loss of the electromagnetic signal is greater than 10, as shown in curve S11. A transmission zero point A and a transmission zero point B are formed in the low-pass filter 20, and the rejection bandwidth of the low-pass filter 20 at −25 dB is generally 11.5 GHz.

While embodiments of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A low-pass filter comprising:
an input line for input of an electromagnetic signal;
an output line for output of the electromagnetic signal;
a high impedance transmission line comprising a first connecting portion electrically connected to the input line, and a second connecting portion electrically connected to the output line;
a first low impedance transmission line comprising a third connecting portion electrically connected to the first connecting portion, and a first free end;
a second low impedance transmission line comprising a fourth connecting portion electrically connected to the second connecting portion, and a second free end; and
a stub comprising a fifth connecting portion electrically connected to the first connecting portion and the second connecting portion, and a third free end.

2. The low-pass filter as recited in claim 1, wherein the input line and the output line have impedance values of approximately 50 ohms, respectively.

3. The low-pass filter as recited in claim 1, wherein the input line is aligned with the output line.

4. The low-pass filter as recited in claim 1, wherein the input line and the output line are symmetrical about the stub.

5. The low-pass filter as recited in claim 1, wherein the first low impedance transmission line is parallel to the second low impedance transmission line.

6. The low-pass filter as recited in claim 1, wherein a slot is formed between the first low impedance transmission line and the second low impedance transmission line.

7. The low-pass filter as recited in claim 6, wherein the slot is opposite to the third free end of the stub.

8. The low-pass filter as recited in claim 1, wherein the stub has a trapeziform profile.

9. The low-pass filter as recited in claim 8, wherein a width of the third free end is greater than that of the fifth connecting portion.

10. The low-pass filter as recited in claim 1, wherein the stub has a rectangular profile.

11. The low-pass filter as recited in claim 1, wherein a length and a width of the first low impedance transmission line are equal to those of the second low impedance transmission line, respectively.

12. A low-pass filter comprising:
an input line for input of an electromagnetic signal;
an output line for output of the electromagnetic signal;
a high impedance transmission line electrically connected to the input line and the output line;
a first low impedance transmission line electrically connected to the high impedance transmission line;
a second low impedance transmission line electrically connected to the high impedance transmission line; and
a stub electrically connected to the high impedance transmission line and disposed in the high impedance transmission line;
wherein the input line and the output are symmetrical about the stub.

13. The low-pass filter as recited in claim 12, wherein the high impedance transmission line comprises a first connecting portion electronically connected to the input line, and a second connecting portion electrically connected to the output line.

14. The low-pass filter as recited in claim 13, wherein the stub comprises a connecting portion electrically connected to the first connecting portion and the second connecting portion, and a free end.

15. The low-pass filter as recited in claim 14, wherein a slot is formed between the first low impedance transmission line and the second low impedance transmission line, and opposite to the free end of the stub.

16. The low-pass filter as recited in claim 14, wherein the stub has a trapeziform profile.

17. The low-pass filter as recited in claim 16, wherein a width of the free end is greater than that of the connecting portion.

18. The low-pass filter as recited in claim 12, wherein the stub has a rectangular profile.

19. A filter comprising:
an input line for electrical connection to input an electromagnetic signal into said filter;
an output line for electrical connection to output said electromagnetic signal out of said filter;
a high impedance transmission line electrically connectable between said input line and said output line to transmit said electromagnetic signal therebetween;
a pair of low impedance transmission lines arranged side by side beside said high impedance transmission line and electrically connectable with said high impedance transmission line to treat said electromagnetic signal transmitted therethrough for said filter; and
a stub extending from said high impedance transmission line between said input line and said output line to define an extending free end away from said high impedance transmission line and a connecting portion electrically connectable with said high impedance transmission line, at least one portion of said stub between said free end and said connecting portion spaced neighboring said high impedance transmission line.

20. The filter as recited in claim 19, wherein said high impedance transmission line is arranged to extend symmetrically about said stub between said input line and said output line.
